(19) United States
(12) Patent Application Publication
(10) Pub. No.: US 2008/0191470 A1
(43) Pub. Date: Aug. 14, 2008

(54) Pipe Bend, and Method of Making a Pipe Bend

(75) Inventor: Alexander Esser, Warstein (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: ESSER-WERKE GMBH & CO. KG, Warstein (DE)

(21) Appl. No.: 11/916,606

(22) PCT Filed: Aug. 16, 2006
(86) PCT No.: PCT/DE2006/001432

§ 371 Date: Dec. 5, 2007

(30) Foreign Application Priority Data
Oct. 27, 2005 (DE) 10 2005 051 766.8

(51) Int. Cl. F16L 43/00; B23P 17/00

(52) U.S. Cl. 285/179; 29/890.149

(57) ABSTRACT

The invention relates to pipe bend (1) for a pipeline used in the fluidic transport of solids and to a method for producing the pipe bend. The pipe bend (1) includes a double-layer pipe body (2) comprised of an inner pipe bend (3) and an outer pipe bend (4). A coupling collar (6) is fixed to each pipe end (5) of the pipe body (2). The annular gap (8) between the inner pipe bend (3) and the outer pipe bend (4) is filled with concrete as filler (9). The annular space (8) is filled via a fill opening (10) in the wall (11) of the inner pipe bend (3), with the fill opening extending transversely across the wall and arranged on the inner radius I_{Ri} of the inner pipe bend (3). Centering aids (12, 13) are hereby introduced into the ends of the pipe body (2), and the inner pipe bend (3) and the outer pipe bend (4) are positioned in relation to one another by the inflation of the centering aids (12, 13). The filling gun (19) of a filling device (20) is then placed against the fill opening (10) in the wall (11) of the inner pipe bend (3), and the annular space (8) is filled with the filler (9).

The invention relates to a pipe bend for a pipeline for fluidic transport of solids, and to a method of making such a pipe bend.

DE 101 43 290 A1 discloses a pipe bend with a double-layer pipe body which is formed from an inner pipe bend and an outer pipe bend. The annular space between the inner pipe bend and the outer pipe bend may be filled with filler as pressure compensating layer. The wall of the outer pipe bend is hereby formed with a bore via which the gap between the inner pipe bend and the outer pipe bend is filled. The bore is subsequently cleaned, welded shut, polished and over-polished. This is time-consuming and cost-intensive. In addition, the bore poses a potential weak spot in the comparably thin-walled outer pipe bend.

Starting from this prior art, the invention is based on the object to provide a pipe bend which is easier to manufacture and more reliable and to provide a method for its manufacture.

As far as the item is concerned, the object is attained by a pipe bend according to the features of claim 1.

The essence of the invention resides in the feature to provide the inner pipe bend with a fill opening for the filler. The annular space between the inner ring bend and the outer ring bend can be filled via the feed opening. The presence of a bore in the outer ring bend and the accompanying weakening of the pressure-resistant outer ring bend are eliminated. There is also no need for a cumbersome cleaning process and aftertreatment of the outer ring bend.

Suitably, the fill opening extends transversely across the wall of the inner ring bend, as set forth in claim 2.

According to an especially advantageous improvement of the basic inventive idea is set forth in claim 3. Accordingly, it is provided to arrange the fill opening on the inner radius of the inner ring bend. The invention is hereby cognizant of the fact that the inner radius of the inner ring bend is least exposed to wear. Thus, the fill opening in the inner ring bend is shifted to a zone of least strain.

Various materials may basically be used as filler. The filler assumes the function of a pressure compensating layer so that the inner ring bend which is sensitive to impact and shock is well supported and in as flat a contact as possible in the outer ring bend. Especially suitable is the use of concrete as filler (claim 4).

As far as the method is concerned, the object is attained by a method with the features of claim 5. Accordingly, a pipe bend according to the invention is made by assembling the inner pipe bend as well as the outer pipe bend and the coupling collars including possibly integrated wearing rings to form a pipe body. The coupling collars are welded to the outer pipe bend. Subsequently, centering aids are inserted into the ends of the pipe body and the inner pipe bend and the outer pipe bend are positioned in relation to one another by means of the centering aids. Thereafter, the annular space between the inner pipe bend and the outer pipe bend is filled with filler by a filling device which is introduced into the pipe body and placed against a fill opening in the wall of the inner pipe bend.

This procedure is efficient and permits a filling of the annular space from the inside of the pipe bend. Cumbersome finishing works or also cleaning of the inner pipe bend is not required.

During filling, the centering aids provide a positional orientation of the inner pipe bend within the outer pipe bend. After conclusion of the filling operation, the centering aids remain active long enough for the solidification or hardening of the filler to progress to such a degree that the inner pipe bend is reliably secured in the outer pipe bend.

According to the subject matter of claim 6, the centering aids for positioning the inner pipe bend and the outer pipe bend are inflated. The centering aids include hereby a pneumatically or hydraulically actuated swell body, for example in the form of a rubber sleeve. As the swell bodies of the centering aids are actuated, the inner pipe bend is positioned in the outer pipe bend and restrained during the fill operation. At the same time, the centering aids and their swell bodies provide a sealing function on the pipe ends of the pipe bend. In particular the gap between the inner pipe bend and the inner wearing ring of the coupling collar is hereby sealed by the swell bodies.

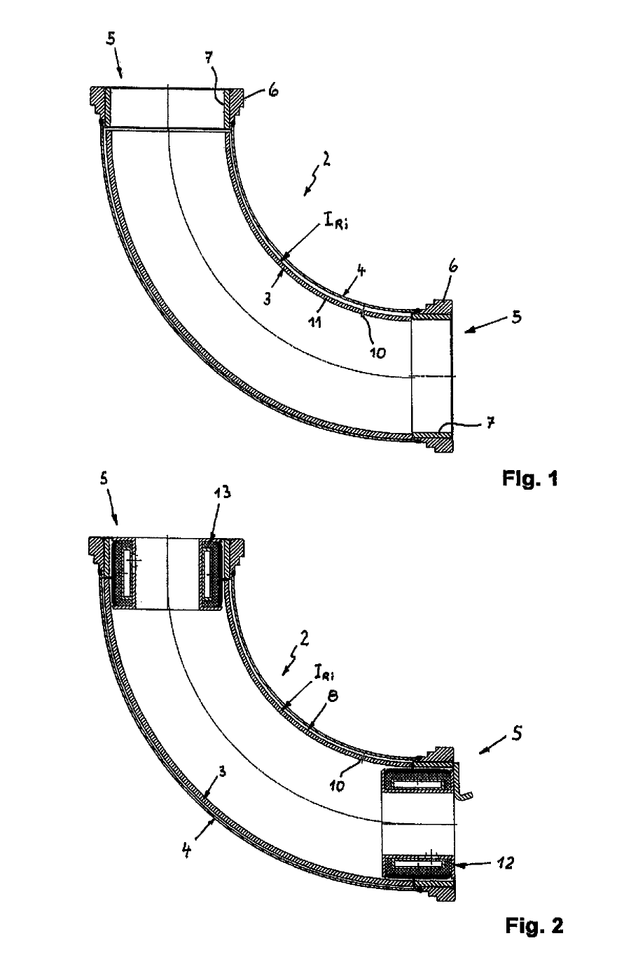

A pipe bend according to the invention and its manufacture will now be described in greater detail with reference to the attached drawings. FIGS. 1 to 6 show various stages of the manufacturing process of a pipe bend.

A finished pipe bend 1 is shown in FIG. 6. The pipe bend 1 is used as part of a pipeline for fluidic transport of solids, for example in the distributing boom of mobile concrete pumps.

As shown in particular in FIG. 2, the pipe bend 1 includes a double-layer pipe body 2 comprised of a highly wear-resistant hardened inner pipe bend 3 and a pressure-resistant weldable outer pipe bend 4. Each pipe end 5 of the pipe body 2 has fixed thereon a coupling collar 6. Each of the coupling collars 6 is placed in surrounding relationship to an inner wearing ring 7 and welded to the outer pipe bend 4.

The annular space 8 between the inner pipe bend 3 and the outer pipe bend 4 is filled with concrete as filler 9. The filler 9 is introduced by providing on the inner radius I_{Ri} of the inner pipe bend 3 a fill opening 10 which extends transversely across the wall 11 of the inner pipe bend 3 (see also FIGS. 1 to 5).

The pipe bend 1 is made through assembly of inner pipe bend 3, outer pipe bend 4, and coupling collars 6 with integrated wearing rings to form the pipe body 2. Normally, a coupling collar 6 including the wearing ring 7 is initially secured and welded to a pipe end 5 of the outer pipe bend 4. Then, the inner pipe bend 3 is inserted into the outer pipe bend 4 and the coupling collar 6 is mounted at the other pipe end 5.

FIG. 1 shows the unfilled pipe body 2. The inner pipe bend 3 rests loosely in the outer pipe bend 4.

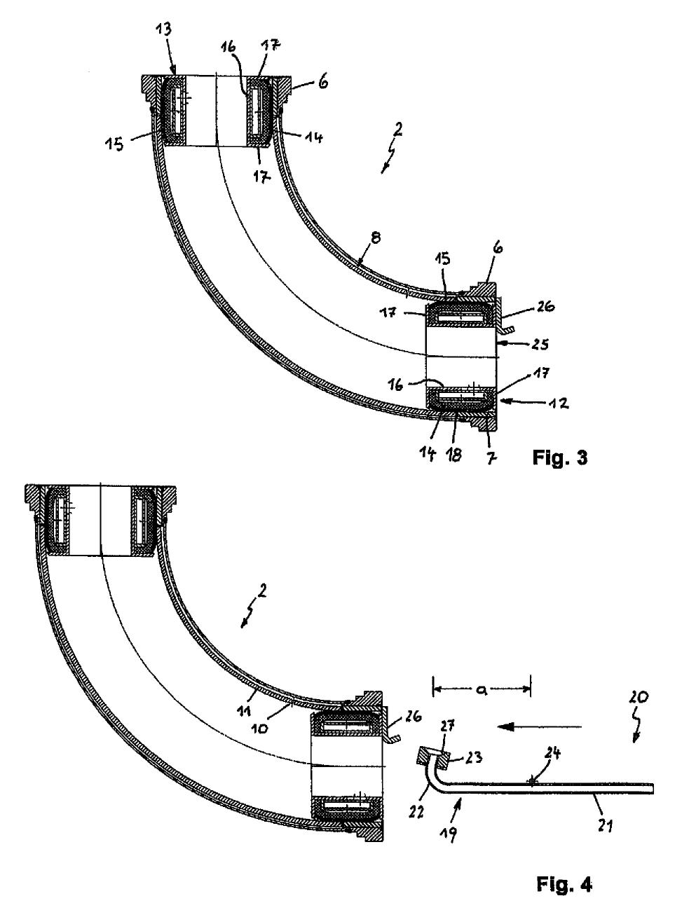

Thereafter, centering aids 12 and 13 are inserted into the respective ends of the pipe body 2 and the inner pipe bend 3 is centered in the outer pipe bend 4 (FIG. 2). Each centering aid 12, 13 includes hereby a swell body 14 with a circumferential radial sealing sleeve 15. The swell bodies 14 are arranged on a central sleeve 16 with lateral wrap-around support rings 17. The inner pipe bend 3 is positioned and secured in the outer pipe bend 4 upon inflation of the swell body 14. Furthermore, the gap 18 between the inner pipe bend 3 and the anterior wearing rings 7 is sealed (FIG. 3).

Then, a filling gun 10 of a filling device 20—as shown in FIG. 4—is inserted into the pipe body 2. The filling gun 19 has a straight feed tube 21 with a terminal curved portion 22 and a fill head 23. The annular space 8 between inner pipe bend 3 and outer pipe bend 4 is filled by placing the fill head 23 of the filling gun 10 against the fill opening 10 in the inner pipe bend 3. A hinge bolt 24 is provided on the feed tube 21 at a defined distance a to the fill head 23. The filling gun 19 with the hinge bolt 24 is hooked onto a hook member 26 which is provided on the free end face 25 of the centering aid 12, for securing the filling gun 10 and generating the contact pressure upon the fill head 23. Hook member 26 and hinge bolt 24 form a pivot point bearing P. A sufficiently high contact pressure can be generated upon the fill head 23 as a result of the lever action so that the annular space can be reliably filled. The distance a between fill head 23 and hinge bolt 24 is sized to enable the fill head 24 to meet the fill opening 10 on the inner radius I_{Ri} of the inner pipe bend 3, when the hinge bolt 24 is hooked onto the hook member 26. This can be facilitated by providing the fill head 23 on the outlet side with an outlet 27 which widens in the form of a funnel.

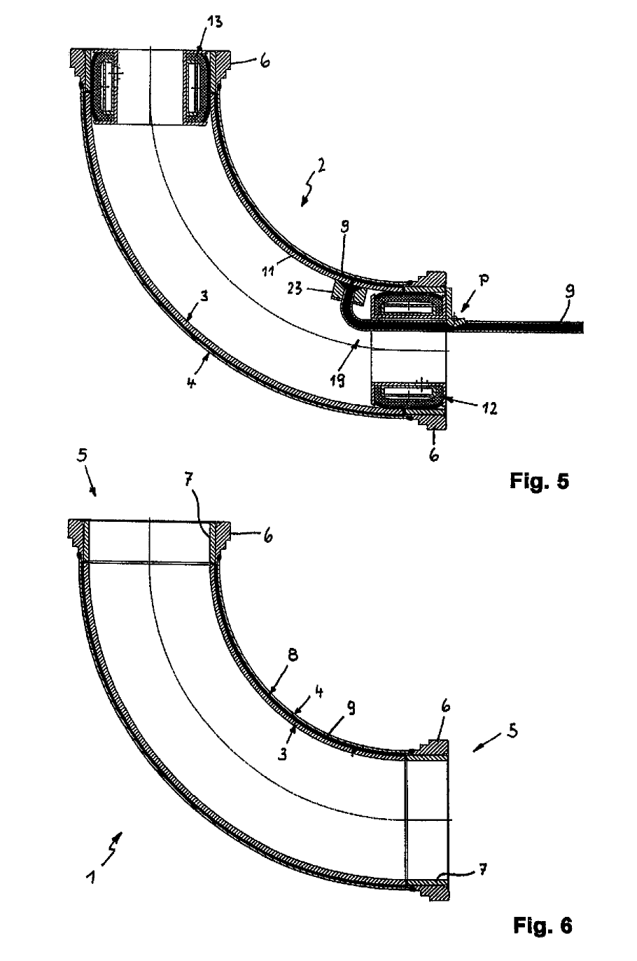

The filling operation is shown in FIG. 5. The filler flows through the filling gun 19 via the fill head 23 through the fill opening 10 into the annular space 8 between inner pipe bend 3 and outer pipe bend 4, and fills it. The annular space 8 is hereby filled completely with filler 9 so that the inner pipe bend 3 is supported flatly in the outer pipe bend 4.

When the filling operation is over, the centering aids 12, 13 remain in position long enough for the filler 9 to bind and cure so that the inner pipe bend 3 can no longer change its position within the outer pipe bend 4.

As noted above, a finished pipe bend 1 is shown in FIG. 6.

### LIST OF REFERENCE SYMBOLS

1—pipe bend
2—pipe body
3—inner pipe bend
4—outer pipe bend
5—pipe end
6—coupling collar
7—wearing ring
8—annular space
9—filler
10—fill opening
11—wall of 3
12—centering aid
13—centering aid
14—swell body
15—sealing sleeve
16—sleeve
17—support ring
18—gap
19—filling gun
20—filling device
21—feed tube
22—curved portion
23—fill head
24—hinge bolt
25—end face of 12
26—hook member
27—outlet
I_{Ri}—inner radius of 3
a—distance
P—pivot point bearing

1.-6. (canceled)

7. A pipe bend for a pipeline for fluidic transport of solids, comprising a double-layer pipe body including an inner pipe bend provided with a fill opening, and an outer pipe bend, wherein an annular space is defined between the inner pipe bend and the outer pipe bend and is filled with a filler introduced via the fill opening of the inner pipe bend.

8. The pipe bend of claim 7, further comprising a coupling collar secured to a pipe end of the outer pipe bend.

9. The pipe bend of claim 8, wherein the coupling collar is welded to the pipe end of the outer pipe bend.

10. The pipe bend of claim 7, wherein the fill opening extends transversely across a wall of the inner pipe bend.

11. The pipe bend of claim 7, wherein the inner pipe bend is defined by an inner radius, said fill opening being arranged on the inner radius of the inner pipe bend.

12. The pipe bend of claim 7, wherein the filler is concrete.

13. A method of making a pipe bend, comprising the steps of:
placing an inner pipe bend within an outer pipe bend to form a double-layer pipe body;
inserting a centering aid into each pipe end of the pipe body to position the inner pipe bend and the outer pipe bend in relation to one another; and
inserting a filling device into the pipe body and placing the filling device against a fill opening in a wall of the inner pipe bend to introduce a filler into an annular space between the inner pipe bend and the outer pipe bend.

14. The method of claim 13, further comprising the step of attaching a coupling collar to a pipe end of the of the outer pipe bend before the inner pipe bend is placed in the outer pipe bend.

15. The method of claim 14, wherein the attaching step includes the step of welding the coupling collar to the pipe end of the outer pipe bend.

16. The method of claim 13, further comprising the step of inflating the centering aid for positioning the inner pipe bend and the outer pipe bend.
